(19) United States
(12) Patent Application Publication
(10) Pub. No.: US 2005/0001712 A1
(43) Pub. Date: Jan. 6, 2005

(54) RF ID tag

(76) Inventor: Craig D. Yarbrough, Dallas, TX (US)

Correspondence Address: HOWISON & ARNOTT, L.L.P, P.O. BOX 741715, DALLAS, TX, 75374-1715, US

(21) Appl. No.: 10/613,173

(22) Filed: Jul. 3, 2003

(51) Int. Cl. H04Q 1/00

(52) U.S. Cl. 340/5.82; 340/825.49

(57) ABSTRACT

An identification tag holder includes an identification tag shell containing a transmitter. An identification card is placed into the identification tag shell. An identification tag interface reads identification data from the identification tag which is transmitted by the transmitter. A remote indentification tag identification system includes one or more remote identification tag components each having an identification tag reader and a transmitter. An identification tag is inserted into the identification tag component, such that identification data may be read from the identification tag by the identification tag reader. A location receiver receives identification data transmitted by the transmitter. A location processor processes said received identification data.

### TECHNICAL FIELD OF THE INVENTION

This invention is related to identification system, in particular identification using transmitted signals.

### BACKGROUND OF THE INVENTION

The need to positively identify, monitor and track both personnel and equipment is a growing concern. Mistakes in identification can be disastrous and exceedingly costly.

One form of identification is the identification tag. The identification tag is typically a token or card with some information written on it. Identification tags may include the name, rank, serial number, home address, date of birth, social security number, a photo-likeness, a signature or any other information that might be used to identify the bearer. In most cases, a person will inspect the identification tag and confirm the bearer's identity. Identity may be used to grant access to a building, facility, base or other place that can be accessed. Identity may also be used to grant access to equipment. Identity may be used to authorize a financial transaction, such as a credit card, debit card or bank transaction. In some cases, the information written on an identification tag is machine-readable, such as on a magnetic strip or bar code. This allows an automated or semi-automated identification process as the identification card is presented to a reader or automatically read. The reader may be connected to a computer or other system that may use the read information to access further information from a database and present the retrieved information on a display to a guard who can then confirm or deny identity and, where appropriate, access.

Another form of identification is a key. Authorized access is assumed to be established by having an appropriate key. A key is typically a token, although a key may also be an information sequence such as a combination, password or a one-time-pad key. A transmitter may be used as a key to achieve wireless access authorization. A toll tag is a key that uses a passive transmitter to identify an automobile and authorize a financial transaction to collect the toll from the account associated with the automobile.

Reliance on persistent human attention on an identification process becomes questionable as the stakes involved with proper identification rise. Access to secure locations, equipment or facilities may require careful control, far beyond the tolerances for human mistake or inattention. At the same time, it is important that the identification process be efficient, flexible and where necessary, completely automated.

What is needed, therefore, is a reliable, flexible and automated method and system of identification.

### SUMMARY OF THE INVENTION

The present invention disclosed and claimed herein, in one aspect thereof, comprises an identification tag holder including an identification tag shell containing a transmitter. An identification card is placed into the identification tag shell. An identification tag interface reads identification data from the identification tag which is transmitted by the transmitter. A remote identification tag identification system includes one or more remote identification tag components each having an identification tag reader and a transmitter. An identification tag is inserted into the identification tag component, such that identification data may be read from the identification tag by the identification tag reader. A location receiver receives identification data transmitted by the transmitter. A location processor processes said received identification data.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a remote identification tag component;

FIG. 2 illustrates a top view of a remote identification tag component;

FIG. 3 illustrates an identification tag;

FIG. 4 illustrates a remote identification tag component circuit;

FIG. 5 illustrates a identification tag reader;

FIG. 6 illustrates a remote identification tag component with an identification tag;

FIG. 7 illustrates a biometric input on the remote identification tag component;

FIG. 8 illustrates a keypad input on the remote identification tag component;

FIG. 9 illustrates a remote identification tag identification system;

FIG. 10 illustrates a flowchart for an identification process;

FIG. 11 illustrates a flow chart for an identification process;

FIG. 12 illustrates a biometric data flowchart;

FIG. 13 illustrates a vehicle identification process;

FIG. 14 illustrates a remote identification tag component; and

FIG. 15 illustrates a passive transmission circuit.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

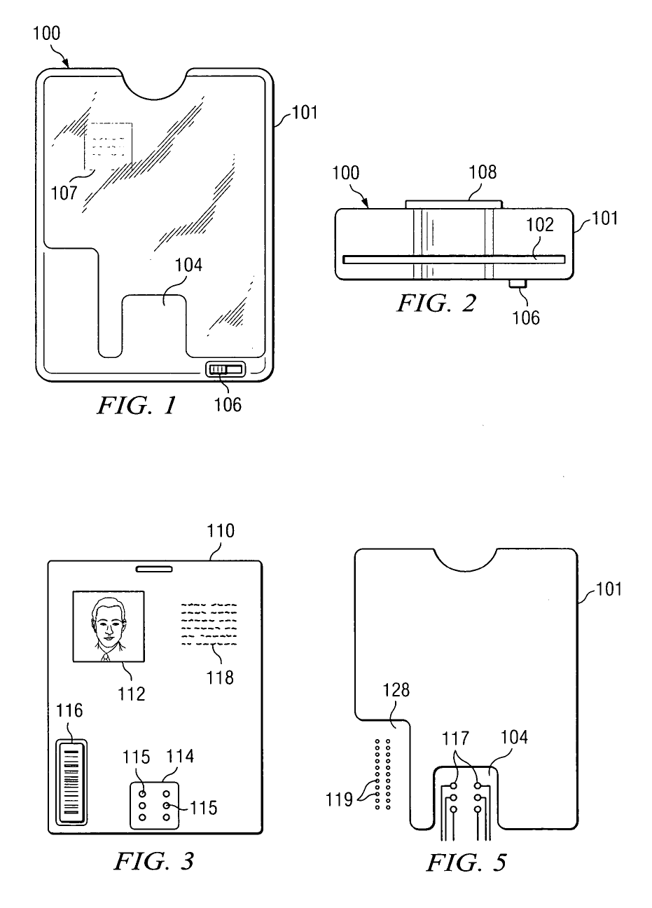

With reference to FIGS. 1 and 2, a radio frequency identification device (RFID) unit 100 in accordance with one embodiment is shown. RFID unit 100 includes an RFID shell 101. The RFID shell 101 is preferably made of plastic and is slightly larger than the ID tag 110. The RFID shell includes an ID tag slot 102. When an ID tag 110 is inserted into the ID tag slot 12, the ID tag 110 is frictionally held in place by the RFID shell 101.

In accordance with the preferred RFID shell 101 includes smart card connector 104. The smart card connection 104 includes smart card leads 120. The smart card contacts 115 on smart card chip 114 are in electrical contact with the smart card leads 120 of the smart card connection 104 when the ID tag 110 is positioned in the RFID unit 100. The smart card connection 104 is further connected to processing circuitry within the RFID unit, such that the processing circuitry of the RFID unit 100 can access data stored on the smart card chip 114 via the smart card connection 104.

The RFID unit 100 includes a panic switch 106. The panic switch 106 is typically a small switch positioned so that it can be switched inconspicuously by a user presenting the RFID unit 100 under duress. When the panic switch 106 is activated, the RFID unit 100 typically functions normally but transmits a panic signal. The panic signal alerts the system that the user is acting under duress. The system response to a panic signal may be programmed into the system, or may simply present the information for action by appropriate authorities.

In accordance with the preferred embodiment, the RFID unit 100 includes a thumb print reader 108. The thumb print reader 108 senses the pattern of ridges on a user thumb and outputs data related to the thumb print. The RFID unit 100 processes the thumb print data to verify the identity of the user.

With reference to FIG. 3, a typical ID tag 110 is shown. The RFID unit 100 may be enabled to read a variety of ID tags 110, although typically the RFID unit 100 will be designed for a specific type of ID tag 110 or similar types of ID tags 110. In accordance with the preferred embodiment, the ID tag 110 is a smart card. The ID tag 110 may be a military identification tag, a government or corporate identification tag, an equipment or vehicle registration tag, a drivers license, a school identification tag, or any other card-shaped object associated with a person or thing which includes some type of readable stored data.

ID tag 110 may include a photo image 112 of the person or thing identified. The ID tag 110 may include a smart card memory 114 including smart card chip contacts 115. The smart card memory 114 will typically be a flash memory chip. ID tag 110 may include information written on the face of the ID tag 110 in the form of a bar code 116. In accordance with the preferred embodiment, the bar code 116 is a two-dimensional bar code. One dimensional bar codes may also be used. ID tag 110 may include textual data 118, including the name of the person, serial numbers and other data which may help identify the person or thing identified by the ID tag 110. The ID tag 110 may also include official seals or other indicia designed to verify the authenticity of the ID tag 110.

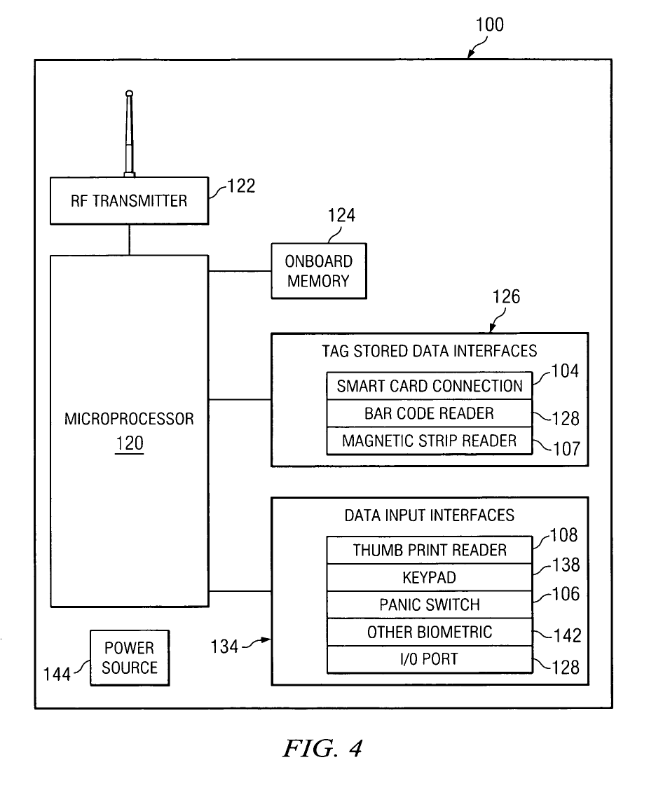

With reference to FIG. 4, a block diagram of the process circuitry for an RFID unit 100 is shown. The RFID unit 100 includes a microprocessor 120. In accordance with the preferred embodiment, microprocessor 120 is a general purpose computing device. Alternatively, microprocessor 120 may be any processing circuit capable of performing the necessary data processing functions, including but not limited to a processing circuit specifically designed for use in an RFID unit 100. It will be apparent to those having skill in the art that the processing requirements of a specific embodiment of the RFID unit 100 will depend on the type of ID tag 110 being used with the RFID unit 100, and the identification protocols used by the RFID system 146. The microprocessor 120 will typically be a single chip, but it will be recognized by those having skill in the art that multiple processing chips may be used to perform the various functions of microprocessor 120.

Microprocessor 120 is communicably connected to an RFID transmitter 122. In accordance with the preferred embodiment, RFID transmitter 122 is an RF transmitter. One having skill in the art will recognize that other forms of communication transmission could be implemented. A transceiver may be implemented to provide two-directional communication, in particular for handshake or authentication protocols requiring an exchange of communication signals.

Typically, the RFID transmitter 122 will modulate signals from the microprocessor 120 and radiate the modulated signals from an antenna. Particularly where security is an issue, more sophisticated communication protocols, such as spread spectrum, could be implemented. Limitations on practical power supplies will generally limit the usefulness of such an implementation for personnel identification. Power may not be a limitation in an RFID system 146 used for tracking and monitoring equipment.

In the preferred embodiment, RFID transmitter 122 is an active, low power, short range transmitter. In some security environments, it may be essential that the range of RFID transmitter 122 be carefully controlled, to prevent monitoring of personnel and equipment by unauthorized receivers. Alternative embodiments may use a passive transmitter, such that the transmitter 122 only transmits data when external energy is supplied. An interrogation system may be implemented where RFID transmitter 122 is a transceiver, such that data is only transmitted after an interrogation signal is received.

The microprocessor 120 is connected to onboard memory 124. The onboard memory 124 will typically store the RFID's processing algorithms as well as provide temporary data storage for the microprocessor 120 during processing. More than one form of onboard memory 124 may be implemented. Flash memory could be implemented as onboard memory 124 to allow changes via memory replacement rather than other, typically slower, input means.

One or more data interfaces are connected to microprocessor 120. The data interfaces are primarily used to provide data for the identification processes and protocols. Data interfaces may also be used to upgrade the RFID software or otherwise alter system data.

A tag stored data interface 126 provides an interface to read data stored on ID tag 110. The type of tag stored data interface 126 required by a particular implementation will depend on the specifications of the ID tag 110, in particular the parameters of the ID tag storage system. A smart card reader 104 provides electrical contacts 120 for connection to a smart card chip 114. Data stored on the smart card memory 114 can be accessed by the microprocessor 120 via the smart card reader 104. A bar code reader 128 is used to read data written on the ID tag 110 as a bar code 116. A magnetic strip reader 107 reads data written on a magnetic strip ### attached to the reverse side of the ID tag 110. The data may be read as needed by the microprocessor 120, as in the case where the data is written on a smart card memory 114 or bar code 116. The data may be read as the ID tag 110 is inserted into the RFID unit 100 and stored in onboard memory 124 until the microprocessor 120 requires the data. The microprocessor 120 may write data in the smart card memory 114.

A data input interface 134 provides an interface to allow a user to input data into the RFID. The type of data input interface 134 required for a particular implementation will depend on the necessary data inputs. A thumb print reader 108 is used for collecting data regarding a user thumb print. A keypad 138 is used for the input of a personal identification number (PIN) or other data strings. A panic switch 106 is a binary input which is used to identify the situation where the user is acting under duress. Other biometric inputs 142 may be implemented to introduce other biometric data for identification of the user. An I/O port 128 may be implemented to provide direct serial communication between the RFID and a system computer or other digital device. The I/O port 128 may be used to upgrade the RFID algorithms or other system data.

In accordance with the preferred embodiment, the processing of the biometric data is performed by the microprocessor 120. The biometric data may, alternatively, be transmitted for processing by another processor. By performing the processing at the RFID unit 100, the validation of the biometric data can be performed at the RFID unit 100, such that the RFID unit 100 need only transmit a verification signal to the RFID receiver 156. Because the bandwidth of the RFID transmission is typically limited, transmitting smaller amounts of data is preferred. The biometric data associated with a fingerprint, for example, may only be a few kilobytes of data. Even the transmission of this relatively small amount of data would be extensive for a small RF transmission system. By performing the verification at the RFID unit 100 and transmitting a verification signal rather than the raw biometric data, a more efficient system is created. In accordance with the preferred embodiment, the verification signal will be a hash of the biometric data, or some other reductive transformative function, to help prevent spoofing of the RFID verification signal. The hash function can be replicated by the system, verifying to the system that the biometric data was actually verified. A predictable verification signal would allow an unauthorized user to circumvent the biometric verification process and simply send the predicted verification signal to the system.

In alternate embodiments, the biometric data may be collected by the RFID unit 100 and transmitted to the RFID receiver 156 for processing by the RFID receiver 156 or sent to the computer for processing. This is particularly useful when the ID tag 110 lacks storage capacity, such as an ID without a smart card chip. Processing of the inputted biometric data may still be performed by the RFID unit 100, such that the processed biometric data is transmitted by the RFID unit 100 to the RFID receiver 156 for comparison with biometric data stored in the RFID system database 162.

In accordance with the preferred embodiment, identification data is stored on the ID tag's smart card memory. Identification data may be stored on the ID tag 110 as a bar code 116. The bar code 116 may be a one-dimensional bar code or a two-dimensional bar code. In one embodiment, the bar code 116 may be read by the tag holder. Alternatively, the bar code 116 may be read by a bar code reader, such that the ID tag 110 is placed proximate to the bar code reader, allowing the bar code reader to receive the data in the bar code. Identification data may be stored on a magnetic strip, such as typically placed on the reverse side of an ID tag 110. In one embodiment, the RFID unit 100 may include a magnetic head to read the magnetic strip on insertion of the ID tag 110 into the RFID unit 100.

In accordance with the preferred embodiment, the biometric data input of the RFID unit 100 includes a pad 108 for collecting fingerprint data. When the user is being identified, the user is instructed to press a finger, typically the right thumb, against the biometric pad 108 on the reverse side of the RFID unit 100. Sensors in the biometric pad collect data regarding the pattern of ridges on the thumb. This biometric data is then processed by the RFID unit 100 to create biometric ID data. The biometric ID data is then compared to the biometric ID data stored on the smart card memory 114. If the input biometric ID data is substantially equivalent to the stored biometric ID data, a biometric validation signal is generated and transmitted to the RFID receiver 156. If the input biometric ID data is not substantially equivalent to the stored biometric ID data, a biometric alert signal is generated and transmitted to the RFID receiver 156.

A typical biometric comparison process may include scanning in a fingerprint and digitizing the scanning signals to produce a matrix of print image data representing pixels. The process divides the print image data into cells, each including a number of pixel data for contiguous pixels. A matrix of directional image data DI is calculated using gradient statistics applied to the cells. The directional image data DI includes, for each of the cells, a cell position indicator and one of a cell vector indicative of a direction of ridge lines and an unidirectional flag indicative of a nondirectional calculation result. The process skeletonizes the print image data, and extracts minutiae from the print image data and producing a minutia data set including minutia position data and minutia direction data. The minutia data set is compared to a stored minutia data set associated with the user's a reference fingerprint. If the comparison shows similarity beyond a similarity threshold, the fingerprint is validated.

Those having skill in the art will recognize that other types of biometric input and validation may be implemented. Other types of biometric input may replace the fingerprint input, or may be enabled as a supplemental biometric verification system. Because any identification system is inherently vulnerable to spoofing, the more methods of identification that are implemented, the more difficult it is to impersonate an authorized user. A power source, such as a battery, is provided in the RFID unit 100 to provide power to any parts of the RFID unit 100 requiring power, including the microprocessor 120 and the transmitter 122.

With reference to FIG. 5, a surface of the RFID frame 101 including the smart card reader 104 and the bar code reader 128 are shown. Bar code reader 128 includes a plurality of LED's 119 and photo sensors 121, connected to microprocessor 120. To read the bar code 116, light is generated by LED's 119. The light is reflected off the black/white pattern of the bar code 116 and the reflected light is detected by photo sensors 121. By sensing differences in the intensity of the reflections, the bar code data is read. Smart card reader 104 includes a plurality of electrical contacts 117. When the electrical contracts 117 are in contact with smart card contacts 115, the data in the smart card memory 114 can be read.

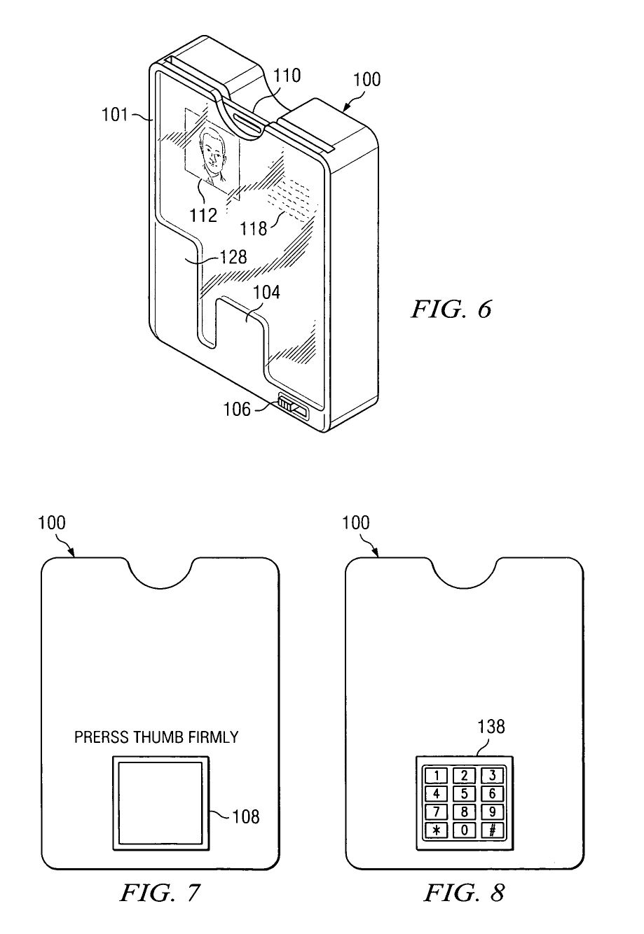

With reference to FIG. 6, an RFID unit 100 in accordance with one embodiment, with an ID tag 110 inserted is shown. The RFID unit 100 includes a smart card reader 104 and a bar code reader 128. With ID tag 110 inserted into the RFID unit 100, the RFID unit 100 can access data stored on the ID tag 110, use the stored data to perform one or more identification protocols and transmit data regarding the identification of the user.

With reference to FIG. 7, the reverse side of an RFID unit 100 including a thumb print reader 108 is shown. When the user presses a thumb against the thumb print reader 108, sensors detect the ridges of the user's thumb. The data generated by the sensors is provided to microprocessor 120 for processing.

With reference to FIG. 8, the reverse side of an RFID unit 100 including a keypad 138 is shown. The keypad 138 is used to input a PIN or other data string, particularly for identification purposes. While keys associated with numerals are shown, any number of keys or labels on the keys may be implemented as appropriate.

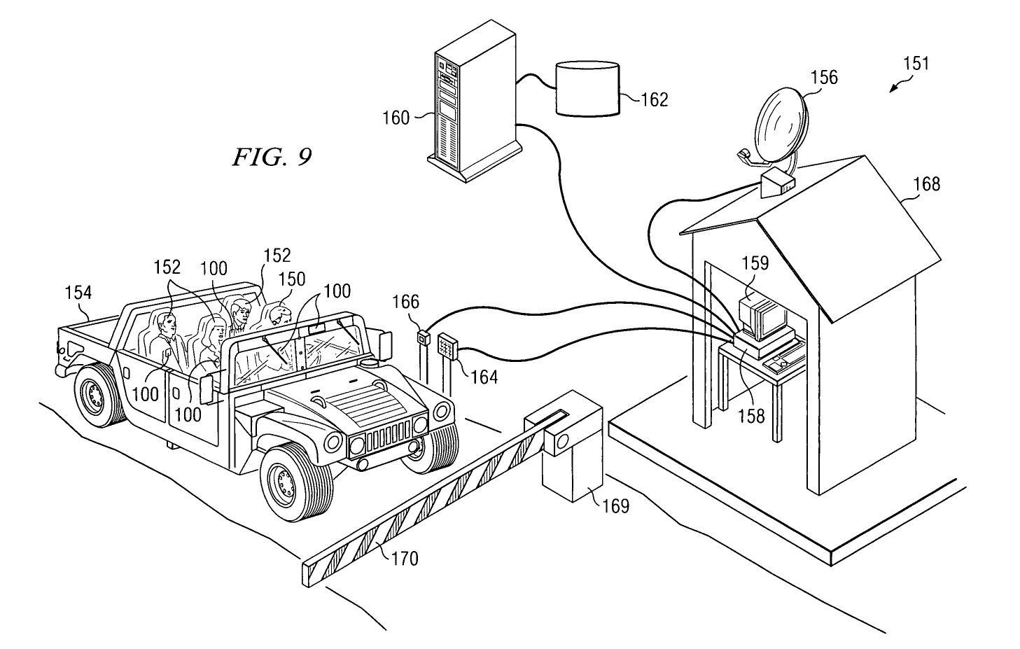

With reference to FIG. 9, an RFID system 151 is shown. An access station 168 and access barrier 170 establish an access point past which RFID units move. Typical access points are building entrances, gated community entrances, school facilities, government facilities, a point of sale (POS) and basically any point where some kind of identification may be required. The access station 168 may be a guard station including a computer 158 or where there is no human component to the RFID system, the access station 168 may consist of RFID computer 158. RFID computer 158 may be a general purpose computer. RFID computer 158 is a personal computer in the preferred embodiment, but may be any processing device capable of performing the RFID system functions, including a processing device specifically designed to perform RFID functions. Where a guard is part of the RFID system operation, RFID computer 158 may have an RFID computer display 159. Other embodiments may include a specialized RFID computer 158 without a computer display 159.

The computer 158 is connected to RFID receiver 156, for receiving RFID signals from RFID 100. RFID receiver 156 is a radio frequency communication receiver, in accordance with the preferred embodiment. RFID receiver may be a transceiver or the RFID receiver may work in cooperation with an RFID transmitter, for embodiments where two-directional communication protocols are used.

In accordance with the preferred embodiment, the transmission power of the RFID 100 is low, so the RFID receiver 156 will preferably be placed close enough to the RFID units 100 to receive the transmissions of the RFID 100 reliably. Other embodiments might utilize directional antennas or an otherwise sensitive receiver to achieve reliable reception of the RFID 100 transmitted signals where the RFID receiver 156 needs to be placed at a greater distance from the RFID units 100.

An access barrier control mechanism 169 for opening or unlatching a gate, door, or other access barrier 170 is connected to the RFID computer, in accordance with the preferred embodiment. The access barrier 170 typically will physically restrict access, although in alternate embodiments the access barrier may act as a symbolic restraint. In embodiments where the RFID system is used for identification, monitoring or tracking, or in less secure environments where access is controlled by a guard rather than an access barrier, there may be no need for an access barrier. As well, an access barrier may be controlled by a guard, acting in response to identification data generated by the RFID system 151 rather than controlled automatically by the RFID computer 158.

In accordance with the preferred embodiment, RFID computer 158 is connected to an RFID server 160. RFID server 160 provides additional processing capability and centralized data management. RFID server 160 is shown connected to an RFID database 162. RFID database 162 includes data regarding the RFID system 151 including personnel data and equipment data. The data stored by the RFID database 162 may be cross-correlated, matching personnel with equipment and facilities, allowing the RFID system 151 to control access to facilities and equipment on a realtime basis to specific personnel at specific times.

Those having skill in the art will recognize that RFID server 160 and RFID database 162 may be enabled with a single networked computer, or a distributed collection of networked computers and storage. RFID computer 158 may contribute processing power and data storage space to the enablement of the RFID server 160 and RFID database 162. The RFID server 160 and RFID database 162 permit installation of a plurality of RFID access points, all managed from a central base. Particularly in RFID systems 151 where monitoring and tracking of personnel and equipment is a principal function, the ability to collect data from different access points and centralize the data allows the RFID system 151 a more distributed ability to monitor and track the location of personnel and equipment than individual RFID systems 151 which are not communicably connected.

Depending on the security requirements of the RFID system implementation, the RFID computer 158 may be connected to the RFID server via an open network like the Internet or a closed network. In the case where the connection is made using an open network, security protocols like SSL may be implemented to assure some measure of security in the communication. As is typical with these types of systems, there is a trade-off between the accessability of the data collected by the RFID system 151 and the achievable security level with regard to the data. These types of design choices will be implemented in accordance with the accessibility and security requirements of the implementation.

RFID computer 158 may also be connected to one or more input devices, including a keypad 164 or a biometric input pad 166. These input devices may be used to add additional security protocols to the RFID system 151, particularly where the RFID 100 does not support all the necessary security protocols. In addition to being identified by the transmission of the RFID 100, the user may be identified by entering an access code or other identification number into keypad 164. Biometrics like fingerprints may be entered using biometric input pad 166. Providing alternate means to authenticate identity may increase the security of the RFID system 151 and may allow RFID systems 151 which are not fully implemented, such as might be the case where only some personnel have a biometric input pad 108 on their RFID 100. Where the RFID system 151 requires biometric input, any personnel not having a biometric input pad 108 on the RFID 100 may be required to use the RFID computer's biometric input pad 166 to provide the necessary thumb print.

In accordance with one embodiment, a vehicle 154 including a driver 150 and passengers 152 approaches an access point. The vehicle 154 has an RFID unit 100 attached to it. The vehicle's RFID unit 100 transmits vehicle identification data to the RFID receiver 156. The RFID receiver 156 sends the vehicle identification data to the RFID computer 158. The RFID computer 158 processes the vehicle identification data or sends the vehicle identification data to the RFID server 160 for processing. The RFID computer 158 may query the RFID server 160 for data, where necessary. In some RFID system 151 implementations, the identified vehicle 154 may be granted access and the RFID computer 158 will cause access control barrier mechanism 169 to open the access barrier 170, permitting the identified vehicle 154 access to the facilities.

In accordance with the preferred embodiment, the driver 150 has an RFID unit 100 assigned to him. Each passenger 152 may also have an RFID unit 100 assigned to them. The driver and passenger RFID units 100 transmit personnel identification data to the RFID receiver 156. The RFID receiver 156 sends the personnel identification data to the RFID computer 158. The RFID computer 158 processes the personnel identification data or sends the personnel identification data to the RFID server 160 for processing. The RFID computer 158 may query the RFID server 160 for data, where necessary. When the personnel have been identified, they may be granted access and the RFID computer 158 will cause access control barrier mechanism 169 to open the access barrier 170, permitting the identified personnel access to the facilities. In alternative embodiments, the identity of the driver 150 may be correlated to the identified vehicle 154 to determine if the driver 150 is authorized to operate identified vehicle 154. Other determinations based on the identities of the driver 150, passengers 152, vehicle 154 or other identified equipment may be made. In embodiments including monitoring and tracking functions, the identification data may be transmitted by the RFID computer 158 to the RFID server 160 for storage in the RFID database 162.

The RFID unit 100, in operation, transmits identification data to the RFID receiver 156. The identification data transmitted by the RFID unit 100 may include an RFID identification number. The RFID identification number uniquely identifies the RFID unit 100. The RFID identification number is typically assigned to the RFID unit 100 when the RFID unit 100 is initialized, but may be reassigned at a later time. In cooperation with an ID tag 110, the RFID unit 100 transmits ID tag identification data to the RFID receiver 156. In accordance with the preferred embodiment, the ID tag identification data is stored in the smart card memory 114 of the ID tag 110. The ID tag identification data is read from the smart card memory 114 using the smart card reader 104 of the RFID unit 100. The ID tag identification data may also be stored in a bar code 116, a magnetic strip or textually on the ID tag 110. The RFID unit 100 reads the ID tag identification data from the ID tag 110. The RFID microprocessor 120 may encode or otherwise transform the RFID identification number and ID tag identification data for security.

Where the RFID unit 100 is used to identify personnel, the RFID unit 100 may transmit personnel identification data to the RFID receiver 156. The personnel identification data may include an identification number such as a serial number, registration number, student number, social security number or any other number associated with an individual, group or other identifiable organization. The term “identification number” is understood to mean an alphanumeric string used for identification. The personnel identification data may include a digitized photograph of the personnel. The personnel identification data may include biometric data associated with the personnel. In accordance with the preferred embodiment, the personnel identification data includes biometric verification data, where the verification data is associated with the right thumb print of the identified personnel.

Other data associated with the identified personnel may be transmitted by the RFID unit 100 to the RFID receiver 156. Credit card numbers, personal or official information regarding the identified personnel are typical of the kinds of data that may be transmitted.

Where the RFID unit 100 is used to identify equipment, the RFID unit 100 may transmit equipment identification data to the RFID receiver 156. The equipment identification data may include an identification number such as a serial number, registration, VIN, license plate number or any other number associated with a piece of equipment or group of equipment. The term “identification number” in this instance is understood to mean an alphanumeric string used for identification. The type of equipment being identified and the purposes for which the equipment is being identified may determine the form of equipment identification data used.

Other data associated with the identified equipment may be transmitted by the RFID unit 100 to the RFID receiver 156. Data regarding authorized users of the equipment or responsibility for equipment are typical of the kinds of data that may be transmitted.

Other types of data, in particular data used for security purposes, may also be transmitted by the RFID unit 100 to the RFID receiver 156. Data regarding personnel access permissions is typical of the kinds of data that may be transmitted.

In accordance with one embodiment, communications between the RFID unit 100 and an RFID transceiver 156 may be used to authenticate the RFID unit 100 and the RFID system 146 to each other. This type of communication as well as other handshaking operations may be implemented. The RFID unit 100 may also receive an interrogation signal from the RFID transceiver 156 to begin the identification process.

RFID database 162 may include RFID serial numbers. Each RFID unit 100 will typically be programmed with an RFID serial number when the RFID unit 100 is activated, commissioned or assigned. The RFID database 162 may include ID tag identification numbers or other data stored on the ID tag 110. ID tag identification data may be associated with other personnel data or equipment data stored in RFID database 162.

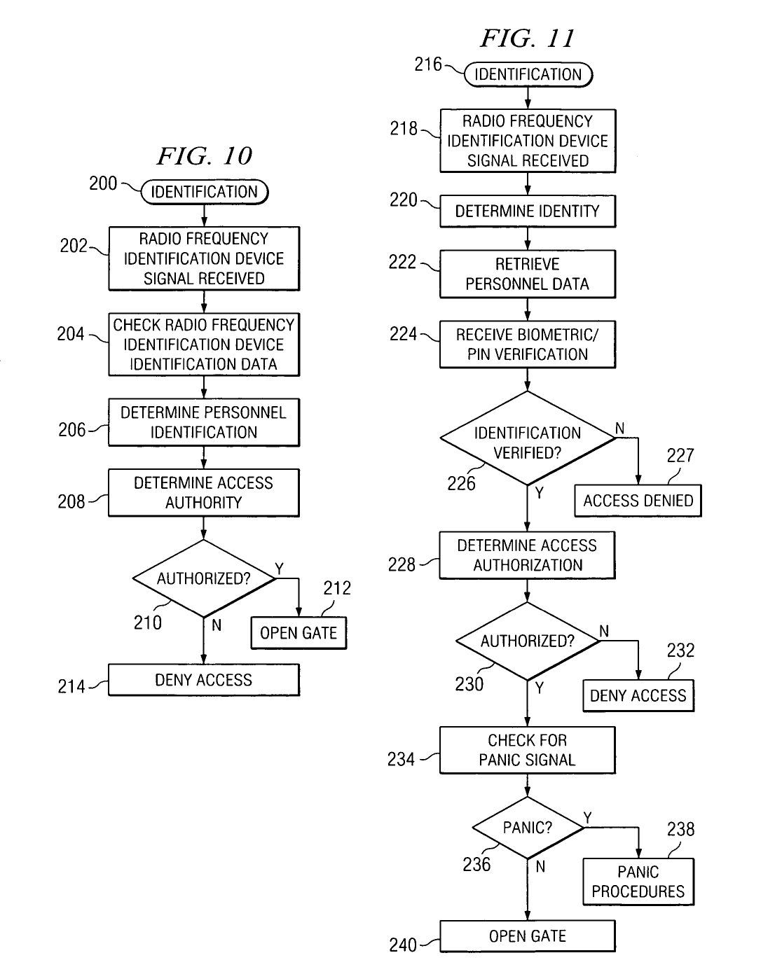

With reference to FIG. 10, an algorithm for identification using the RFID system 146 is shown. The identification process begins in block 200. An RFID signal is received by the RFID receiver 156 from an RFID unit 100 in block 202. The RFID system 146 checks the RFID identification data in block 204 and determines the identity of the person carrying the RFID unit 100 in block 206. The RFID system checks the access permissions of the identified person in block 208. Access authorization is determined in decision block 210. If the person is authorized access, the process follows the YES path and RFID system 146 opens access barrier 170 in block 212. If the person is not authorized access, the process follows the NO path and the RFID system 146 proceeds with a standard “DENY ACCESS” protocol.

With reference to FIG. 11, an algorithm for identification using the RFID system in accordance with another embodiment is shown. The identification process begins in block 216. When an RFID unit comes proximate to an RFID receiver, an RFID identification signal is received in block 218. The RFID system 146 determines the identity given by the RFID unit 100 in block 220. Checking the RFID database 162, the RFID system retrieves personnel data associated with the identified individual in block 222. The user being identified inputs biometric data into the RFID unit. In accordance with the preferred embodiment, the user being identified presses a thumb against a thumb print reader 108 on the reverse side of the RFID unit 100. The RFID unit 100 processes the biometric data and transmits a biometric verification signal if the input biometric data is adequately similar to biometric data stored on the ID tag 110.

The RFID system 146 receives the biometric verification signal from the RFID unit 100 in block 224. The RFID system then verifies the identity of the individual in decision block 226. If the identity is not verified, then the process continues on the NO path to block 227 where an access denied protocol is followed. If the user's identity is verified, the RFID system 146 determines access authorization for the identified user in block 228. The RFID system 146 checks the authorization access in decision block 230. If the identified user is not authorized access, then a deny access protocol is followed in block 232. If the user is authorized access, the RFID system checks for a panic signal in block 234. If the RFID system 146 determines in decision block 236 that the panic switch has been switched, the process follows the YES path to initiate PANIC procedures in block 238 IF the RFID system 146 determines that the panic switch has not been switched, the process follows the NO path to open access barrier 170.

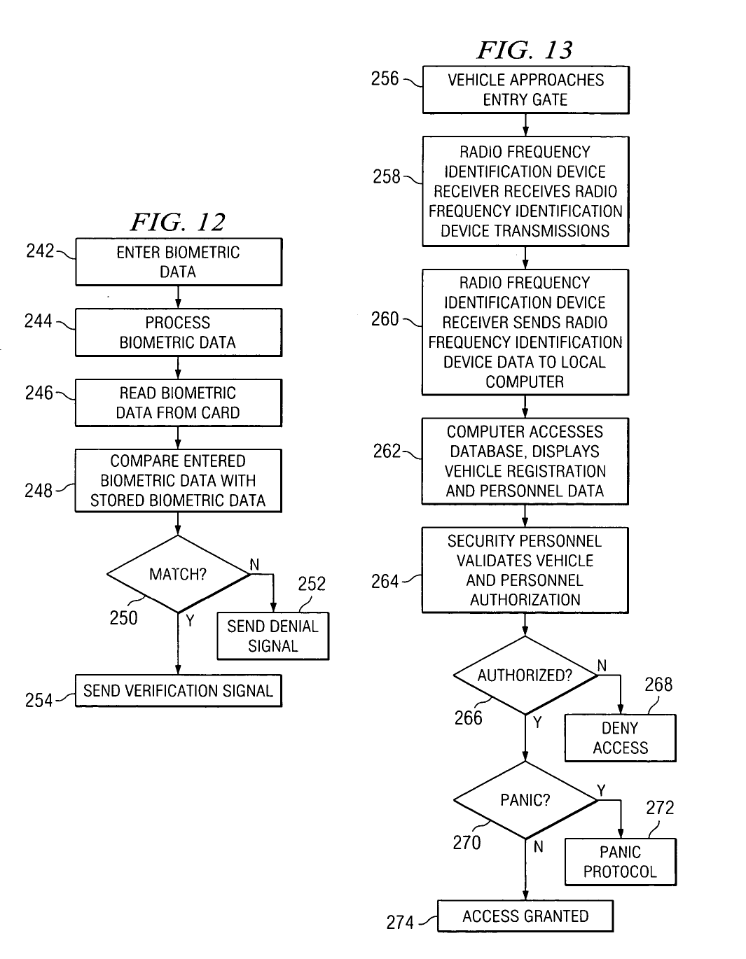

With reference to FIG. 12, an algorithm for biometric comparison is shown. The biometric data is input in block 242. The biometric data is processed in block 244. Stored biometric data is retrieved from the smart card memory 114 in block 246. The RFID unit 100 then compares the input biometric data with the stored biometric data in block 248. If there is a match in decision block 250, then the process follows the YES path and sends a biometric verification signal to the RFID receiver 156 in block 254. If there is not a match, then the process follows the NO path and sends a biometric denial signal in block 252.

With reference to FIG. 13, an algorithm for vehicle and driver identification using the RFID system 146 is shown. A vehicle containing a driver and passengers approaches the gate in block 265. The RFID units 100 assigned to the vehicle, driver and passengers each transmits an RFID signal for reception by an RFID receiver 156 in block 258. The RFID receiver 156 receives the RFID signals and relays the signals to the RFID computer 158 in block 260. The RFID computer 158 access RFID database 162 and correlates the vehicle identification data with the personnel identification data in block 262. Security personnel, such as a guard, validates the vehicle and personnel authorization displayed at the RFID computer 158.

If the vehicle and users are not authorized access in decision block 266, the process follows the NO path to follow a DENY ACCESS protocol in block 268. If the users are authorized access, the process follows a YES path to decision block 270. If a panic switch has been switched, the process follows the YES path to follow a PANIC protocol in block 272. If the panic switch has not been switched, the process follows the NO path and access is granted in block 274.

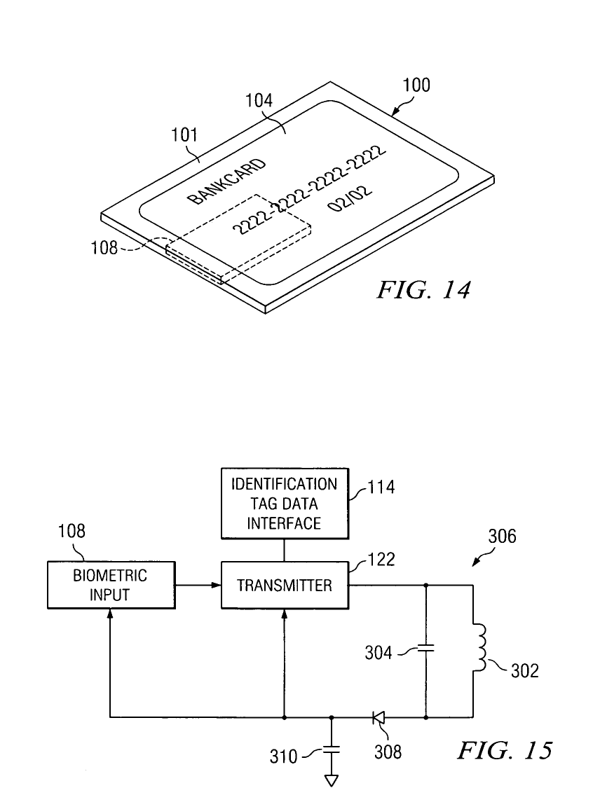

With reference to FIG. 14, a remote identification component 100 is shown in conjunction with an identification tag 104, where the identification is a credit card. Identification tag 104 may be a credit card, bank card, debit card or any other token that may be used to transfer payments. When the identification tag 104 is inserted into the remote identification tag component shell 101, an identification tag data interface 107 reads identification data from the identification tag 104. In the case where the identification tag 104 is a standard credit card, the identification data may be the card number, the name on the card and the expiration date. It will be clear to those having skill in the art that other types of identification data may be read from the identification card.

In accordance with the one embodiment, the RFID tag component 100 contains a passive transmission circuit. Where the RFID tag 100 is used for financial transactions, a passive transmission circuit may be appropriate. The biometric input device 108 may be used in a financial transaction to authenticate the card bearer.

With reference to FIG. 15, a passive transmission circuit is shown. When electromagnetic radiation 306, typically microwave radiation, is radiated on a tank circuit containing an inductor 302 and a capacitor 304, energy flows through rectifier 308 and is captured on capacitor 310. Charged capacitor 310 provides current to transmitter 122 and other active elements of the device, such as the biometric input. Other power sources, such as a battery, may be used to power some or all of the active elements, where appropriate. Transmitter 122 receives identification data from identification tag data interface 114 and biometric data from biometric input 108. Transmitter 122 transmits the identification data and the biometric data. The transmitted data is received by a receiver 156 and the received data is used to authorize a financial transaction. This arrangement allows any credit card to be used in a secure RF transaction. Where the receiver 156 is connected to a soda machine or other point-of-sale system, secure financial transactions can be conducted by inputting biometric data into the RFID tag 100 while proximate to receiver 156.

It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. An identification tag component comprising:
an identification tag shell having an outer surface;
a transmitter;
an identification tag interface communicably connected to said transmitter and adapted to read identification data from an identification tag; and
including means on said outer surface for holding the identification tag in communicable proximity to said identification tag interface;
wherein said transmitter transmits identification data.

2. The remote identification tag holder of claim 1, wherein said transmitter is an active transmitter.

3. The remote identification tag holder of claim 1, wherein said identification tag interface is a smart card memory interface.

4. The remote identification tag holder of claim 1, further comprising a biometric data reader communicably connected to said transmitter.

5. The remote identification tag holder of claim 1, further comprising a processor communicably connected to said transmitter and communicably connected to said identification tag interface.

6. The remote identification tag holder of claim 5, further comprising a biometric data reader communicably connected to said processor.

7. The remote identification tag holder of claim 6, wherein said processor receives input biometric data from said biometric data reader and said processor processes said input biometric data and wherein stored biometric data is stored on the identification card and said processor processes said stored biometric data and said processor determines if the input biometric data is substantially related to the stored biometric data and generates a biometric verification signal and wherein said transmitter transmits said biometric verification signal.

8. The identification tag component of claim 1, wherein said identification data is authorization data.

9. The identification tag component of claim 1, wherein said identification data identifies a person.

10. The identification tag component of claim 1, wherein said identification data identifies equipment.

11. A remote identification tag identification system comprising:
a remote identification tag component having an identification tag reader and a transmitter;
an identification tag in communicable proximity to said identification tag reader;
a location receiver receiving transmissions from said transmitter; and
a location processor connected to said location receiver;
wherein said remote identification tag reader reads identification data from said identification tag and wherein said transmitter transmits said identification data to said location receiver, and wherein said location receiver sends said received identification data to said location processor said wherein location processor processes said received identification data.

12. The remote identification tag identification system of claim 11, further comprising a system identification database in communication with said location processor, wherein said location processor further processes stored identification data.

13. The remote identification tag identification system of claim 11, wherein said location processor provides displayed identification data.

14. The remote identification tag identification system of claim 11, wherein said location processor processes said received identification data to determine identity.

15. The remote identification tag identification system of claim 11, wherein said location processor processes said received identification data to determine authorization.

16. The remote identification tag identification system of claim 11, wherein said authorization is access authorization.

17. The remote identification tag identification system of claim 12, further comprising a second location receiver and a second location processor, wherein said second location processor is in communication with said system identification database.

18. The remote identification tag identification system of claim 11, wherein said identification tag comprises identification data storage memory.

19. The remote identification tag identification system of claim 11, further comprising an access barrier, wherein said location processor processes said received identification to determine access authorization and causes said access barrier to move when access is authorized.

20. The remote identification tag identification system of claim 19, wherein said access barrier is a gate.
